(19) United States
(12) Patent Application Publication
(10) Pub. No.: US 2022/0283446 A1
(43) Pub. Date: Sep. 8, 2022

(54) NOSE BRIDGE FOR EYEWEAR

(71) Applicant: Sean Gerald Sullivan, Henderson, NV (US)

(72) Inventor: Sean Gerald Sullivan, Henderson, NV (US)

(21) Appl. No.: 17/193,508

(22) Filed: Mar. 5, 2021

(51) Int. Cl. G02C 5/12

(52) U.S. Cl. CPC G02C 5/126; G02C 2200/02; G02C 2200/06; G02C 2200/16

(57) ABSTRACT

This disclosure provides a nose bridge for eyewear including a flexible shell, a filler comprising a gel or viscous fluid, and where the shell is substantially filled with the filler. The flexible shell may include an elastomeric material and the filler may include silicone, silicone gel, and/or a saline solution. The flexible shell may preferably include silicone rubber, polyurethane, and/or polyethylene.

### BACKGROUND OF THE DISCLOSURE

### Field of the Invention

This disclosure is generally directed to eyewear including eyeglasses, sunglasses, safety glasses, and goggles, and the like, and more specifically, to nose bridges for such eyewear.

### Description of the Related Art

Traditional eyeglasses, sunglasses, and other types of eyewear, e.g., safety glasses, goggles, etc., generally include a frame with lens assembly that includes a standard nose bridge that typically includes two vertical nose pads. Such nose bridges are fabricated by way of an integrated set of lateral nose pads welded to a wire lens rim wire. In other cases, standard eyewear nose bridges take the shape and form of an injection molded bridge element which is attached to the lateral rim wire or lateral surface of an injected molded frame with or without vertical pads. These nose bridges sit on the exterior lateral side of both sides of the wearer's nose surface.

All conventional eyewear nose bridges inherently aggravate nasal and skin nerves and impede key areas of nasal bridge blood flow because there are significant nerves and blood vessels in the lateral side regions of the human nose. This creates discomfort in many wearers and is a particular problem for anyone who has suffered a break in their nose or who has other post-surgical bone structure issues. Accordingly, there is a need for improved nose bridges in eyewear that are more comfortable and that do not adversely affect a wearer's nose.

### SUMMARY OF THE INVENTION

This disclosure provides a nose bridge for eyewear including a flexible shell, a filler comprising a gel or viscous fluid, and wherein the shell is substantially filled with the filler. The flexible shell may include an elastomeric material and the filler may include silicone, silicone gel, and/or a saline solution. The flexible shell may preferably include silicone rubber, polyurethane, and/or polyethylene.

The nose bridge may be in the form of a bag or saddle design that provides a suspension style fit with contact only on the dorsal surface of the wearer's nose bridge. The nose bridge thus provides a suspension-style, custom fit. The saddle style straddle or flow-contour style may contact only on the top surface of a wearer's nose bridge.

Other features and aspects will be apparent from the following detailed description, the drawings, and the claims.

### BRIEF DESCRIPTION OF THE DRAWINGS

FIG. 1 shows an embodiment of a nose bridge of the disclosure.

FIG. 2 shows an exploded view embodiment of a nose bridge of the disclosure.

FIG. 3A shows one embodiment of a snap-on fit of the disclosure.

FIG. 3B shows another embodiment of a snap-on fit of the disclosure.

FIG. 3C shows another embodiment of a snap-on fit of the disclosure.

FIG. 4 shows another embodiment of a snap-on fit of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The present disclosure provides an eyewear nose bridge that may take the form of a bag, flexible pouch, or the like, filled with a gel or viscous liquid. The disclosed nose bridge provides a suspension-style or saddle style type fit on the top surface of a wearer's nose.

The disclosed eyewear nose bridge avoids contact with the side of a wearer's nose. The disclosed nose bridge therefore avoids a wearer's nose nerves and blood vessels which are generally on the lateral regions or sides of the nose. The disclosed nose bridge fits any size or style of eyewear providing an excellent fit. The disclosed eyewear nose bridge provides a comfortable fit even for wearer's that have suffered past breaks in the nose or who have, for example, nose surgery-related bone structure issues.

In embodiments, the disclosed nose bridge may comprise a flexible shell or plastic pouch filled with a gel-like or viscous liquid composition. The shell may comprise or be composed of a nonallergenic or hypoallergenic material including any nonirritating suitable natural or plastic polymeric material. In embodiments, the pouch or shell material may be or comprise an elastomeric-type material, e.g., a rubber or a silicone rubber, polyurethane, polyester, and/or polyvinyl alcohol. The pouch or shell may be smooth or textured. Filler materials can include silicone gel or saline solution, soy oil, polypropylene string, terylene wool, ground rubber, silastic rubber, and/or teflon-silicone prostheses or combinations thereof. In preferred embodiments, the pouch may comprise silicone gel or a saline solution. The filler material may also be a ‘gummy’ or ‘gummy bear’ type material, generally, thick silicone gel.

Fabrication or manufacture of the disclosed eyewear nose bridge may be similar to current breast implant or prostheses manufacture. That is, injecting a filler material, e.g., silicone or silicone gel into an elastomer flexible shell comprising silicone rubber, polyurethane, or other suitable material. A predesignated shape may be created. Manufacture of the external flexible shell, pouch, or bag to retain the fluid-gel or liquid injected materials to accomplish maximum flow-fit on and around a nose bridge skeletal form can be accomplished. The exterior bag or shell material and production process can ensure the shape of a mold that lasts over time.

The disclosed eyewear nose bridge may be attached to a subject eyewear, for example, by way of adhesive or a mechanical snap-fit or interlocking plastic backing to the eyewear. This allows snap in or channel fit. There may also be, for example, a velcro attachment. Adhesives would generally include any glue or cement-based products generally used for adhering plastic or polymeric products, metals or composites.

In embodiments, the nose bridge may be attached to eyewear via a magnetic connection. In embodiments, a magnet of one polarity may be attached to an eyewear and a magnet of opposite polarity may be attached to a nose bridge. For example, the magnets may be attached using a glue or a cement-based product, but other means of attachment known in the art for attaching small magnets to products and devices are also contemplated. The nose bridge may then be magnetically attached and detached to the eyewear. Magnetic attachments thus provide the convenience of being able to easily swap out different nose bridges on eyewear.

Attachment mechanisms may thus allow for interchange and replacement of the eyewear nose bridge. This permits exchange of sizes. Durometer measurements may provide preferred soft vs hardness, i.e., rigidity. Anti-slip or textured materials may provide for sticky performance, i.e., facial grip in the presence of sweat or humidity. Exchange of the disclosed nose bridge may depend on consumer needs, end use, and the environment.

Snap fit designs can include a full perimeter snap-in, snap-on fit, prolonged snap-in, ball or cylinder snap in fit and can include straight or tapered beam designs. See e.g., Snap-fit, Wikipedia, The Free Encyclopedia, Date of last revision: 22 Feb. 2020, herein incorporated by reference.

The disclosed nose bridge is generally designed to sit on the bridge of a wearer's nose (where there are few veins or nerves) and not (substantially) contact the sides of the nose where there are more veins and nerves. The nose bridge is soft and only minimally contacts the top or bridge of a wearer's nose. The nose bridge may be textured or made slightly sticky to maintain its position on the nose.

The size and shape of a male nose is typically somewhat different from that of a female nose. Male noses are generally larger and project a little further from the face. Female noses are usually smaller and blend in a little more. Male noses are also typically wider at the base with larger nostrils than female noses, which are usually narrower with smaller nostrils.

In terms of shape, noses can vary from round and bulbous, to narrow and pointy. Both men and women can have a variety of shapes to the tip of their nose. The same is true for the bridge of the nose. Males will typically have noses where the bridge is straight or slightly humped. Female noses will sometimes have a bridge that has a little more of a slope, like a bowl. Those who have played sports or participated in physical activities may also sometimes have a slightly crooked nasal bridge from nose injuries. It is well known from anatomy that the majority of blood vessels and nerves in the nose are located in the lateral or side regions of the nose. See Human Nose, Wikipedia, The Free Encyclopedia, Date of last revision: 16 Feb. 2021, herein incorporated by reference.

Variations of shape of the disclosed nose bridge may accommodate a male versus female nose, nose bridge size, form, and shape. Specific shapes may accommodate for global diversity in nose bridge related shapes due to age, ethnicity, skeletal face variations, sizes, etc. For example, an Asian fit style versus a common market fit as known and used in the eyewear industry are contemplated.

As mentioned, based on facial and skeletal position, the location of the disclosed nose bridge can avoid critical nerve and vascular contact, and also reduce or eliminate facial, skin, and skeletal abrasion and aggravation. The disclosed nose bridge eliminates contact, pressure, impediments, or interference with facial nerves and nasal blood flow.

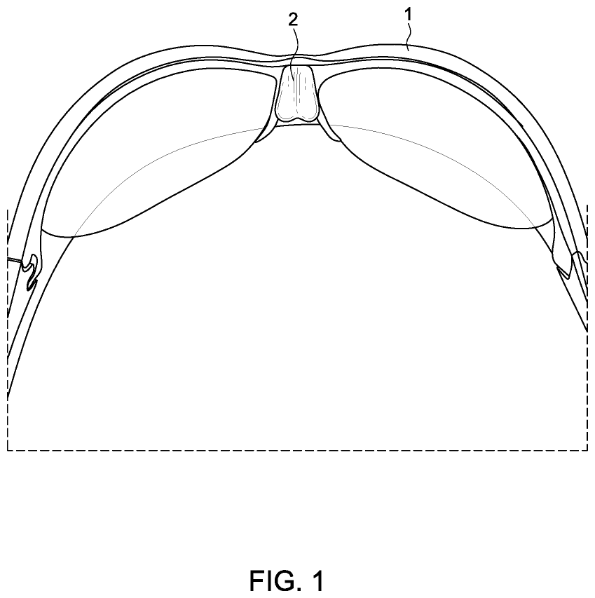

FIG. 1 shows an embodiment of a nose bridge of the disclosure. FIG. 1 shows eyewear frame 1 and nose bridge 2.

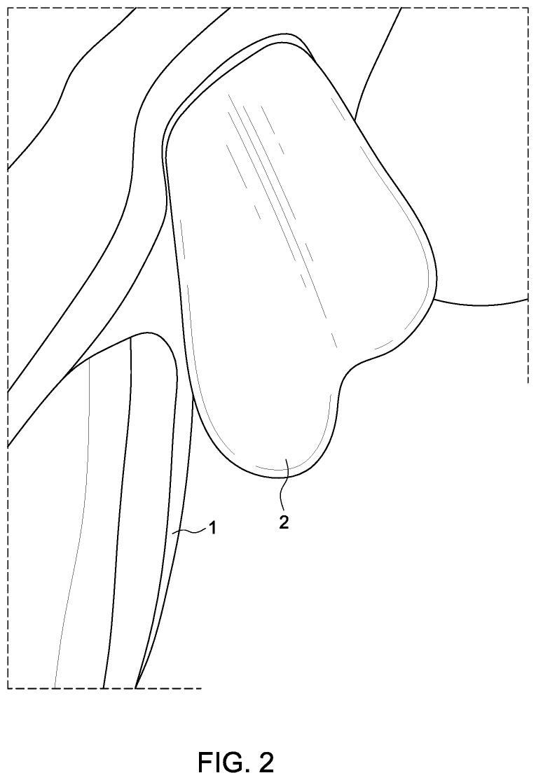

FIG. 2 shows an exploded view embodiment of a nose bridge of the disclosure. FIG. 2 shows eyewear frame 1 and nose bridge 2.

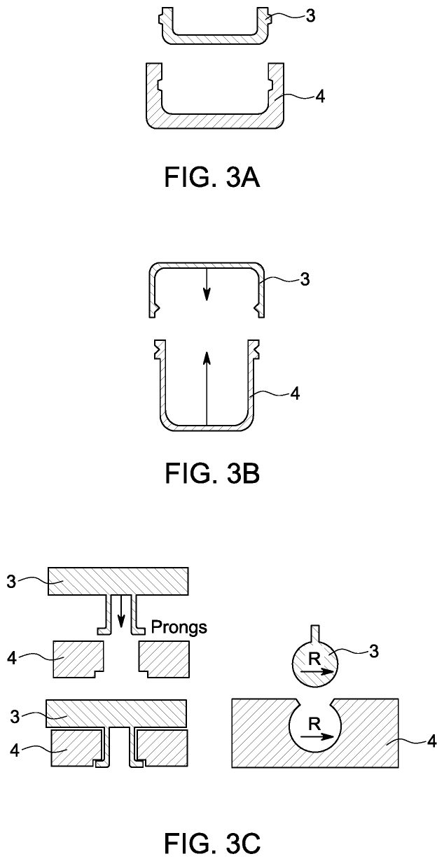

FIG. 3A shows one embodiment of a snap-on fit of the disclosure. FIG. 3A shows base 4 and connector 3. Base 4 is connected to an eyewear frame (not shown) and connector 3 is attached or connected to a nose bridge of the disclosure.

FIG. 3B shows another embodiment of a snap-on fit of the disclosure. FIG. 3B shows base 4 and connector 3. As in FIG. 3A, base 4 is connected or attached to an eyewear frame (not shown) and connector 3 is attached or connected to a nose bridge of the disclosure.

FIG. 3C shows another embodiment of a snap-on fit of the disclosure. As in the previous figures, base 4 is connected or attached to an eyewear frame (not shown) and connector 3 is attached or connected to a nose bridge of the disclosure.

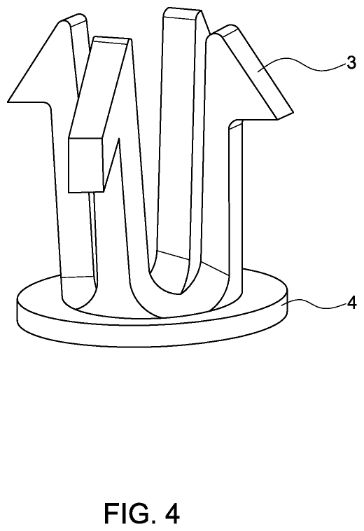

FIG. 4 shows another embodiment of a snap-on fit of the disclosure. FIG. 4 shows another version of base 4 and connectors 3. As in the previous figures, base 4 is connected or attached to an eyewear frame (not shown) and connector 3 is attached or connected to a nose bridge of the disclosure.

Eyewear as contemplated herein generally refers to products worn on or over the eyes, for fashion or adornment, protection against the environment, and to improve or enhance vision. This includes eyeglasses or spectacles, sunglasses, and safety glasses and goggles. Eyewear generally includes a frame, a clear or tinted glass or plastic assembly, and a nose bridge. The frames may be made of metal or plastic or composite. Generally, commonly, commercially, available eyeglasses, and sunglasses, and the like, are contemplated. See Glasses, Wikipedia, The Free Encyclopedia, Date of last revision: 2 Mar. 2021, herein incorporated by reference.

As used herein, a flexible shell refers, as also described above, to a pouch or envelope made typically of an elastomeric material. Elastomers are well known in the art and refer to a polymeric material with viscoelastic properties. Examples include cured and uncured rubbers, polyisoprene, silicone and fluorosilicone rubber, fluoroelastomers, etc. See Elastomer, Wikipedia, The Free Encyclopedia, Date of last revision: 7 Feb. 2021, herein incorporated by reference. In preferred embodiments, the flexible shell comprises silicone rubber and/or polyurethane.

The flexible shell is generally thin in comparison with the dimensions of the nose bridge and may be from 0.05 mm to 10 mm thick. In preferred embodiments the flexible shell or pouch may be 0.1 mm to 10 mm thick or 0.1 to 5 mm thick. The thickness of the flexible shell may vary in different regions of the nose bridge to provide strength or prevent rupture.

The filler is filled in the pouch or flexible shell and may, for example, be injected therein with the shell or pouch being sealed after injection. The filler is generally a gel or viscous liquid such as a saline solution. Viscous saline solutions are known as used in breast prosthesis or implants, but any appropriate viscous liquid or gel is contemplated. Examples include hydrogels, organogels, xerogels, etc. See Gel, Wikipedia, The Free Encyclopedia, Date of last revision: 4 Mar. 2021, herein incorporated by reference. Silicone gel or saline is preferred.

The dimensions and shape of the nose bridge may vary but generally will have an indentation where the nose bridge contacts a wearer's nose. In one example, a saddle shape may be used (see FIG. 1).

In one embodiment, the shape may have two lobes connected with a thinner region in between and with an indentation at the bottom where the nose bridge will contact a wearer's nose. Other geometric shapes such as round, oval, square, parallelogram, rectangular, trapezoidal, cylindrical, triangular, concave and convex polygon, curved and irregular polygons, etc., and modifications and combinations thereof are also contemplated, generally including an indentation to allow the bridge to sit on the wearer's nose.

In embodiments, an indentation in the nose bridge may be a recess or cut in the nose bridge providing a shape generally corresponding to, or fitting with, a wearer's nose bridge. A snug, full contact, fit is preferred. In embodiments the indentation may be broader to fit to a broader bridge of a wearer's nose or more deeply cut or recessed to fit a narrower bridge of a wearer's nose. The dimensions and shape of the indentation thus correspond to the dimensions and shape of the human nose and the bridge of the nose of a wearer. A variety of fits and dimensions for the indentation are contemplated to allow a fit to the full range of human nose bridge shapes and sizes.

In embodiments the nose bridge may have a radius of about 2 mm to about 40 mm, or a length and/or a width ranging from about 5 mm to about 75 mm.

While this disclosure includes specific examples, it will be apparent after an understanding of the disclosure of this application has been attained that various changes in form and details may be made in these examples without departing from the spirit and scope of the claims and their equivalents.

1. A nose bridge for eyewear comprising:
a flexible shell;
a filler comprising a gel or viscous fluid;
wherein the shell is substantially filled with the filler.

2. The nose bridge for eyewear of claim 1, wherein the flexible shell comprises an elastomeric material and the filler comprises silicone, silicone gel, and/or a saline solution.

3. The nose bridge for eyewear of claim 2, wherein the flexible shell comprises silicone rubber, polyurethane, and/or polyethylene.

4. A nose bridge for eyewear of claim 2, wherein the flexible shell thickness ranges from about 0.1 mm to about 1 mm.

5. The nose bridge for eyewear of claim 1, wherein the nose bridge comprises a shape of two lobes and an indentation between the lobes at, or near, where the nose bridge contacts a wearer's nose.

6. The nose bridge for eyewear of claim 1, wherein the nose bridge comprises a round, oval, square, parallelogram, rectangular, trapezoidal, cylindrical, triangular, concave or convex polygon, or curved or irregular polygon shape, comprising an indentation where the nose bridge contacts a wearer's nose.

7. The nose bridge for eyewear of claim 1, wherein the filler comprises a hydrogel, organogel, or xerogel.

8. The nose bridge for eyewear of claim 1, wherein the nose bridge has a length and/or a width in the range of about 10 mm to about 75 mm.

9. Eyewear comprising:
a nose bridge of claim 1, wherein the nose bridge is attached to the eyewear.

10. The eyewear of claim 9, wherein the nose bridge is attached to the eyewear with an adhesive, glue, or cement.

11. The eyewear of claim 9, wherein the nose bridge is attached to the eyewear with a snap-on fit connector.

12. The eyewear of claim 9, wherein the nose bridge is attached to the snap-on fit connector eyewear with adhesive, glue, or cement.

13. The eyewear of claim 9, wherein the nose bridge is attached to the eyewear with a magnetic attachment.
